(19) United States
(12) Patent Application Publication
(10) Pub. No.: US 2019/0372897 A1
(43) Pub. Date: Dec. 5, 2019

(54) SYSTEMS AND METHODS FOR CONGESTION MEASUREMENTS IN DATA NETWORKS VIA QOS AVAILABILITY

(71) Applicant: T-Mobile USA, Inc., Bellevue, WA (US)

(72) Inventors: Matthew Paul Fuerter, San Ramon, CA (US); Ramdane Chouitem, Martinez, CA (US)

(73) Assignee: T-Mobile USA, Inc.

(21) Appl. No.: 15/994,504

(22) Filed: May 31, 2018

(51) Int. Cl. H04L 12/801; H04L 12/927; H04L 12/26; H04L 12/891

(52) U.S. Cl. CPC H04L 47/115; H04L 47/805; H04L 43/10; H04L 47/41; H04L 43/50

(57) ABSTRACT

Systems and methods for providing improved network performance analysis are provided. The system can use a multi-dimensional metric—quality of service (QoS) availability—to provide a more granular picture of network performance. The system can use statistical analysis to provide the probability of receiving a particular level of performance on a network or a portion of a network. The system can use a plurality of user equipment (UEs) to gather network performance data. Some UE can include a dedicated application configured specifically to gather network performance data. Other UE can include an existing application modified to gather network performance data as a secondary function in addition to the application's primary functions. Different types of applications can be used to measure different network performance parameters (e.g., download and upload speeds, delay, latency, jitter, etc.).

### BACKGROUND

Multiple access digital network performance is usually specified in terms of the best-case or average user throughput. In some cases, initial connection latency can be measured as this is also a performance measure that the user senses. The throughput is usually specified for the downlink (DL) direction—i.e., toward the user. In the service industry, service providers generally advertise the best-case throughput. Obviously, advertisement of best case performance is useful because it tends to attract the potential subscribers.

In the case of service providers who provide data communications services to other businesses, there normally exists what is known as a service level agreement (SLA). This agreement provides the specific performance and availability requirements for the service. This agreement will normally state that the purchased service will be available, or usable by the customer, for at least a defined fraction of the time, known as availability. The SLA may state, for example, that the purchased service will be available a minimum 99% of the time, or have 99% availability. If the service is available less than 99% of the time—i.e., there is more than a 1% outage—in any given month, then the SLA is violated. Because no network is completely reliable, the SLA guaranteed availability is generally less than 100%.

Congestion is a term used to describe an overload of a network or network element. Every network element has a certain capacity; once that capacity is exceeded, it will normally be termed as congested. Congestion can lead to a user perceived service degradation, though this is somewhat subjective. In other words, one user may perceive poor performance because of the congestion, while another user with the same experience may not sense the reduced performance/congestion. In addition, different subscriber populations use the various services in different proportions and each service has its own threshold(s) for required performance (e.g., throughput) before an average user would sense the reduced performance.

This subjectivity, along with different performance requirements for each type of service, interfere with defining and determining whether congestion is occurring. As a result, congestion is often inferred. In wireless data networks such as, for example, long-term evolution (LTE) data networks, there are various methods used to infer congestion. Network providers sometimes use a proxy based method to infer congestion. The proxy is a metric, or set of metrics, that closely reflect the user's service experience.

As stated above, the user DL throughput, for example, is a metric that closely mirrors the level of service experienced by a user. DL throughput is often used as the primary metric to infer performance. After a metric, or a set of metrics, is chosen, then an appropriate threshold can be chosen for each metric. If DL throughput is the proxy for network performance, for example, then the threshold could be set somewhere between approximately 2-8 Mbps.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a network including a plurality of user equipment (UE) running applications that can be used to probe the quality of service (QoS) availability of the network, in accordance with some examples of the present disclosure.

FIG. 2 depicts a plurality of probes distributed over a coverage area, in accordance with some examples of the present disclosure.

FIG. 3 is a flowchart that depicts an example method for receiving, compiling, and analyzing probe data to calculate QoS availability, in accordance with some examples of the present disclosure.

FIG. 4 is an example of a UE for use with the systems and methods disclosed herein, in accordance with some examples of the present disclosure.

FIG. 5 is an example of a server for use with the systems and methods disclosed herein, in accordance with some examples of the present disclosure.

### DETAILED DESCRIPTION

Examples of the present disclosure can comprise systems and methods for measuring a new metric—quality of service (QoS) availability—for data networks. The system can use data collected from a dedicated application or an existing application on a plurality of users' equipment (UEs) to directly measure various network performance parameters such as, for example, download speeds, latency, delay, and jitter. The system combines multiple one-dimensional performance measurements into multi-dimensional performance measurements to identify network congestion, coverage, and performance issues, among other things. The system can enable network providers to, for example, identify where more, or better, equipment may be needed, technical problems with equipment, and environmental issues, among other things.

The system is described herein as a system for use with cellular voice and data networks. One of skill in the art will realize, however, that the system is equally applicable to any wired or wireless networks that transmit data. Thus, the system could be applied to Wi-Fi networks or cable internet networks, for example, without departing from the spirit of the disclosure. Thus, the discussion is limited to cellular voice and data networks merely to simplify explanation and not to limit the disclosure.

The multi-dimensional network measurement discussed above can be referred to as “QoS availability,” which specifies the fraction of time, fraction of area, fraction of traffic, etc., over which a certain level of network performance is available. Thus, QoS availability can provide a concise statistical description of the service experienced by a group of users. Congestion, for example, can be defined based on performance availability (e.g., download (DL) throughput, delay, latency, etc.), which can be termed “congestion based QoS availability.”

Service providers generally specify the average performance of a network. Average performance tells us that 50% of the users experience at, or above, the specified level of performance and 50% experience lower than the specified level. In contrast, QoS availability can provide complete insight into the user experience. This is possible because QoS availability contains both the level of performance and the fraction of users that experience that level of performance. Thus, in contrast to the current practice of providing summary performance statistics such as the average, minimum, and maximum, QoS availability can provide a more comprehensive view of performance via the cumulative statistical description of performance and service.

In the telecommunications industry, congestion has typically been a measure of “call” or “session” blocking—e.g., the inability to make a call due to lack of resources. A resource was said to be congested when the blocked call/session fraction exceeded a certain threshold (e.g., 1-5%). With the widespread availability of data communications and the related increase in network throughput, however, congestion has been redefined as a hindrance rather than a complete obstruction. Thus, congestion in data networks results in a throughput reduction and/or an increase in latency, for example, not a complete denial of access. It is this reduction in the level of service that may be perceived by some users as a reduction in network performance or service. The reduction in performance can manifest as slow downloads, videos buffering during playback, and slow internet surfing, among other things.

Conventional network availability merely provides an indication of how often users have service. It does not, however, provide any information about the quality of the service. If the average QoS is known, then the average level of service that the users experience is known, but no other statistics regarding the service other than the average QoS is provided. As a result, there is no direct way to measure or specify the probability of receiving service that is, for example, twice as good as average or half as good as average. There is also no way to concisely specify various metrics such as, for example, “provide 90% of subscribers with a minimum of 5 Mbps of DL throughput.”

The specified network availability or the aggregate users' QoS do not provide the desired information. Network availability merely states the fraction of time that the specific service is available, regardless of the QoS provided (i.e., it is simply a binary measure of network “up” time vs. “down” time). Similarly, as discussed above, QoS states the average service quality provided. Neither metric by itself, however, captures the distribution of users' experiences while using the network (or a specific network node).

To this end, QoS availability is a single concise metric that can be used to describe the distribution statistics of the QoS over a given domain. These domains can include, for example, a probability distribution, a temporal distribution, a spatial distribution, a spatiotemporal distribution, etc. QoS availability is useful because it can be used to provide a concise statistical description of the users' experience and can give a complete picture of QoS experiences over a large set of users. Thus, QoS availability combines the concepts of performance and availability into a flexible two-dimensional metric.

A business, such as a network provider, may desire to provide a DL throughput of 5 Mbps to 90% of its subscribers—a QoS of 5 Mbps with a probability of receiving that 5 Mbps equal to 90%. Of note, the information provided in this description is a combination of QoS and availability. In addition, together, these data provide a complete and concise description of the desired QoS that a set of users is targeted to receive. Of course, not only can one jointly specify a target for these two metrics, but these can be jointly measured as well. As used herein, this concept can be referred to as QoS availability.

In the context of congestion, QoS availability can be used to define the threshold at which congestion begins to occur. Once the QoS availability falls below the target threshold, the resource under consideration can be considered congested. From the example above (greater than 5 Mbps DL throughput @ 90% probability), if the QoS availability drops to 89%, then the resource is considered congested. In this example, the QoS availability is the fraction of data sessions for which the users' throughput equaled or exceeded the performance threshold. Both the performance (e.g., 1, 2, or 5 Mbps for DL throughput) and the percentage (e.g., 80, 85, or 90%) can be set to any value relevant to the service provider. Thus, QoS availability provides a congestion metric based upon the availability of network performance.

Indeed, QoS availability can be used to totally describe the performance of a network node or an entire network. The provider can measure, for example, the percentage of users that are receiving 10 Mbps DL throughput (e.g., 70 or 80%), the percentage of users that are receiving at least 5 Mbps DL throughput (e.g., 85 or 90%) and the percentage of users that are receiving at least 2 Mbps DL throughput (e.g., 95 or 98%). The provider can then make decisions based on a complete picture of the network. 5 Mbps may be desired in urban areas, for example, where users download more data and expect higher performance. 2 Mbps may be desired in rural areas, on the other hand, where users are more forgiving of network performance.

QoS availability can also be used to measure the performance of other metrics such as, for example, delay, latency, and jitter. So, for example, a service provider can set a goal of providing a data service that has a session startup latency of less than 1 ms for 98% of the sessions (less than 1 ms Latency @ 98% probability). Then, if the QoS availability for latency drops below 98%, the network is identified as having a performance degradation or a performance problem, which could be, for example, an outage, interference, congestion, etc. Thus, the system provides a performance metric based upon performance availability.

QoS availability specifies the fraction of time, fraction of area, fraction of traffic, etc., over which a certain level of network performance is available. This concept has broad application in data networks. QoS availability can be used, for example, to specify congestion, performance, availability, or any combination of these one-dimensional metrics.

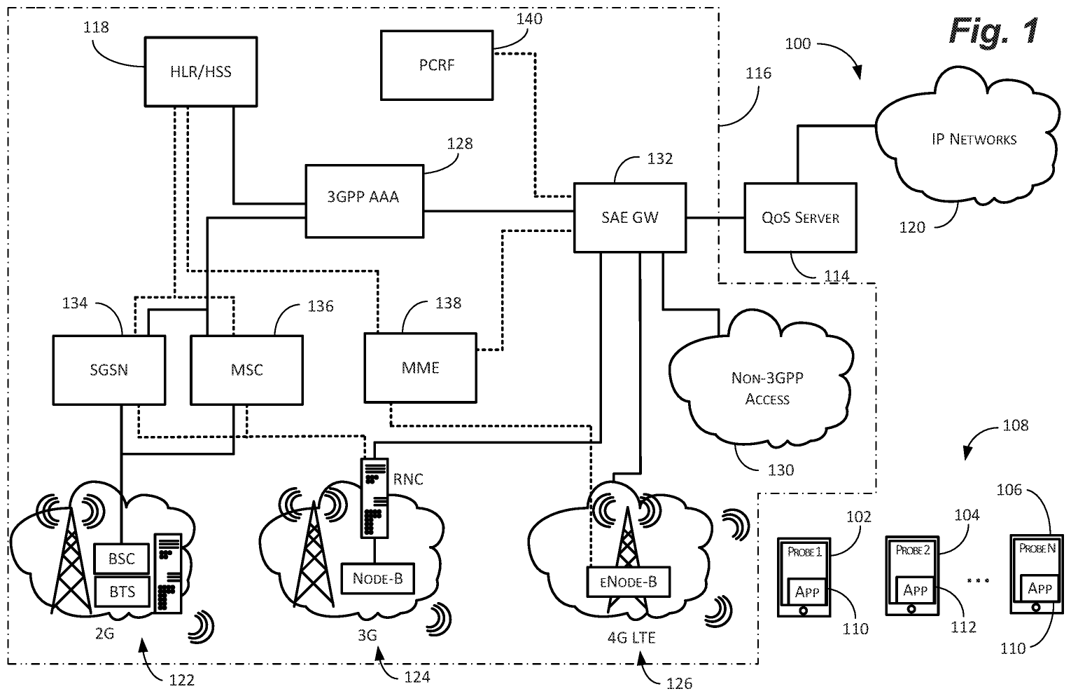

FIG. 1 is an example of such a system 100 for detecting congestion in a data network. The system 100 can include a plurality of UEs 102-106, which can be collectively referred to as “probes 108.” The probes 108 can each run a dedicated application 110 or an “existing” application 112. The UEs 102-106 can comprise, for example, cell phones, smart phones, tablet computers, laptop computers, or any other network-connected device. Indeed, the system 100 can be used in conjunction with any type of transmitted data network; and thus, the UEs 102-106 could be associated with 2G, 3G, 4G LTE, 5G, Wi-Fi, Bluetooth®, wired, internet of things (IoT), or any other kind of network. The system 100 is described herein as being associated with a cellular network 116, but could be used with other types of data and/or voice networks without departing from the spirit of the disclosure. Of course, while three UEs 102-106 are depicted for clarity, in practice data can be collected from hundreds, thousands, or even millions of probes 108, with the accuracy and resolution increasing with the number of probes 108.

The probes 108 can include one or more applications 110, 112 to provide data to a QoS Server 114. In some examples, the application can be a dedicated application 110, specifically designed for use with the system 100. In this configuration, the dedicated application 110 may upload and/or download a test file (e.g., a 5 or 10 MB file) periodically throughout the day to test the performance of the network 116. In other examples, the dedicated application 110 can be used to test upload and download speeds, delay, latency, jitter, and other network performance parameters. Thus, depending on the performance parameter being tested, the dedicated application 110 can upload and/or download files (to test upload and/or download speeds), for example, make repeated requests, or “pings” to test latency, play streaming video to detect jitter, etc. The dedicated application 110 can be programmed to run the test hourly, randomly, at specific times (e.g., time when traffic is highest), or on any other appropriate schedule.

In other examples, the application can be one or more existing applications 112—i.e., one or more applications already in use on the probes 108 for another purpose—that provide a good “test” of the network performance parameter being measured. In other words, existing applications 112 that upload and/or download data to/from the network 116 at the maximum speed possible, such as file transfer protocol (FTP) applications, can be used to test download speeds. Existing applications 112 that stream video, which generally do not “max out” download speeds, can nonetheless be useful to measure jitter and/or latency (i.e., these applications generally make multiple download requests for small packets of the video as the video plays).

For existing applications 112, the applications 112 may already track performance parameters and the data can simply be collected on the probes 108 or can be purchased from the application provider. In other examples, the existing applications 112 can be modified to collect the desired data. The network providers may provide their own applications or may work with application providers to obtain the desired data.

Indeed, the system 100 can utilize a dedicated application 110 and one or more existing applications 112 to provide even more data. Thus, while depicted as a single application 110, 112 on each of the probes 108, in practice the system 100 can utilize multiple applications 110, 112 on each of the probes 108 and/or different apps 110, 112 on each probe 108. So, the system 100 may use an FTP application on a first UE 102, for example, and a streaming application on a second UE 104 to measure different parameters.

Regardless of the type of application 110, 112 used, and whether it is a dedicated application 110 or a function of an existing application 112, the application(s) 110, 112 can enable the probes 108 to measure various performance metrics from the UEs 102-106 side of the equation. In addition, using a variety of applications 110, 112 can provide a variety of data including, for example, different file sizes, UE locations, times of day, etc., as users naturally access data via the one or more applications 110, 112 on the probes 108. This can provide more accurate data than proxy systems, for example, that attempt to simulate network conditions and/or simply add load to the network 116. Instead, the data is being collected directly from the probes 108 using actual network conditions.

The application(s) 110, 112 can provide the data collected by the probes 108 periodically to the QoS server 114. The QoS server 114 can receive and store the data and may also compile and sort the data and perform analysis on the data to identify existing or developing network trends (e.g., congestion and/or other issues). The QoS server 114 may perform statistical analysis such as, for example, calculating cumulative distribution functions for the data. The QoS server 114 can be a standalone server or can be executed by an existing network device such as, for example, the HLR/HSS 118 or 3GPP AAA server 128, discussed below.

For ease of explanation, the system 100 is described herein for use with a cellular network 116. As mentioned above, however, the system 100 could also be used with other types of wired and wireless networks. The cellular network 116 can include, for example, 2G 122, 3G 124, and 4G long-term evolution (LTE) 126 components. Of course, future technologies, such as, for example, 5G, internet of things (IoT), and device-to-device (D2D) components could also be included and are contemplated herein. Many of the “back-end” components of the network 116 are currently involved in various portions of voice and data transmissions from the network 116 to the probes 108. Thus, a portion of the applications 110, 112 and some, or all, of the QoS server 114 could be located on one or more of, for example, the HLR/HSS 118, a 3GPP AAA server 128, or other components. In other words, the applications 110, 112 and QoS server 114 can be standalone or can be at least partially integrated into one of the existing network components.

As is known in the art, data can be routed from the internet or other sources using a circuit switched modem connection (or non-3GPP connection) 130, which provides relatively low data rates, or via IP based packet switched connections, which results in higher bandwidth. The 4G LTE network 126, which is purely IP based, essentially “flattens” the architecture, with data going straight from the internet to the service architecture evolution gateway (SAE GW) 132 to evolved Node B transceivers, enabling higher throughput.

The serving GPRS support node (SGSN) 134 is a main component of the general packet radio service (GPRS) network, which handles all packet switched data within the cellular network 116—e.g. the mobility management and authentication of the users. The MSC 136 essentially performs the same functions as the SGSN 134 for voice traffic. The MSC 136 is the primary service delivery node for global system for mobile communication (GSM) and code division multiple access (CDMA), responsible for routing voice calls and short messaging service (SMS) messages, as well as other services (such as conference calls, fax, and circuit switched data). The MSC 136 sets up and releases the end-to-end connection, handles mobility and hand-over requirements during the call, and takes care of billing and real time pre-paid account monitoring.

Similarly, the mobility management entity (MME) 138 is the key control-node for the 4G LTE network 126. It is responsible for idle mode UEs' 102-106 paging and tagging procedures including retransmissions. The MME 138 is involved in the bearer activation/deactivation process and is also responsible for choosing the SAE GW 132 for the UEs 102-106 at the initial attach and at time of intra-LTE handover involving core network (CN) node relocation (i.e., switching from one cell site to the next when traveling). The MME 138 is responsible for authenticating the user (by interacting with the HLR/HSS 118 discussed below). The non-access stratum (NAS) signaling terminates at the MME 138 and it is also responsible for generation and allocation of temporary identities to UEs 102-106. The MME 138 also checks the authorization of the UEs 102-106 to camp on the service provider's home public land mobile network (HPLMN—for non-roaming users) or visiting public land mobile network (VPLMN—for roaming users) and enforces UEs' 102-106 roaming restrictions on the VPLMN. The MME 138 is the termination point in the network for ciphering/integrity protection for NAS signaling and handles the security key management. The MME 138 also provides the control plane function for mobility between LTE 126 and 2G 122 and 3G 124 access networks with the S3 interface terminating at the MME 138 from the SGSN 134. The MME 138 also terminates the Sha interface towards the home HLR/HSS 118 for roaming UEs 102-106.

The HLR/HSS 118 is a central database that contains user-related and subscription-related information. The functions of the HLR/HSS 118 include functionalities such as mobility management, call and session establishment support, user authentication, and access authorization. The HSS, which is used for LTE connections, is based on the previous HLR and authentication center (AuC) from CGMA and GSM technologies, with each serving substantially the same functions for their respective networks.

To this end, the HLR/HSS 118 can also serve to authenticate the applications 110, 112 to prevent unwanted data access. So, for example, the applications 110, 112 can receive log in information from the user to validate the user and can then provide the HLR/HSS 118 with the necessary credentials to enable the applications 110, 112 to access the network 116. Once authenticated, the HLR/HSS 118 can then ensure the user is authorized to use the requested resources, for example, or send an authorization request to the 3GPP AAA server 128, discussed below.

The policy and charging rules function (PCRF) 140 is a software node that determines policy rules in the cellular network 116. The PCRF 140 generally operates at the network core and accesses subscriber databases (e.g., the HLR/HSS 118) and other specialized functions, such as content handling (e.g., whether the user has sufficient data left in their plan), in a centralized manner. The PCRF 140 is the main part of the cellular network 116 that aggregates information to and from the cellular network 116 and other sources (e.g., IP networks 120). The PCRF 140 can support the creation of rules and then can automatically make policy decisions for each subscriber active on the cellular network 116. The PCRF 140 can also be integrated with different platforms like rating, charging, and subscriber databases or can also be deployed as a standalone entity.

Finally, the 3GPP AAA server 128 performs authentication, authorization, and accounting (AAA) functions and may also act as an AAA proxy server. For wireless local area network (WLAN) access to (3GPP) IP networks 120, the 3GPP AAA server 128 provides authorization, policy enforcement, and routing information to various WLAN components. The 3GPP AAA server 128 can generate and report billing/accounting information, perform offline billing control for the WLAN, and perform various protocol conversions when necessary. Thus, the 3GPP AAA server 128 can determine if the user is authorized to access content and handle some or all of the routing from the HLR/HSS 118 to the applications 110, 112, among other things.

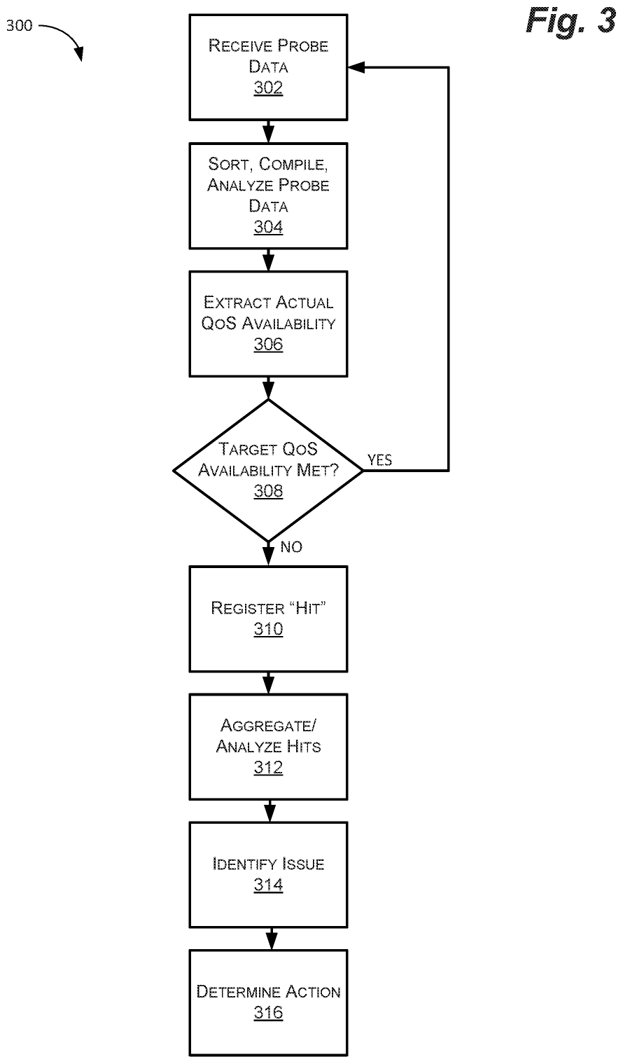

In some examples, the HLR/HSS 118 and/or 3GPP AAA server 128 can contain some, or all, of the components of the system 100. In some examples, the HLR/HSS 118 and/or 3GPP AAA server 128 can include, for example, the QoS server 114, and other functions. Of course, as mentioned above, other components (e.g., the PCRF 140 or MME 138) could also include some, or all, of the system 100. In addition, most of these components have a direct impact on network performance. Thus, poor latency, for example, may be caused by a slow or out-of-date 3GPP AAA server 128. The process of locating issues is discussed below with respect to FIG. 3.

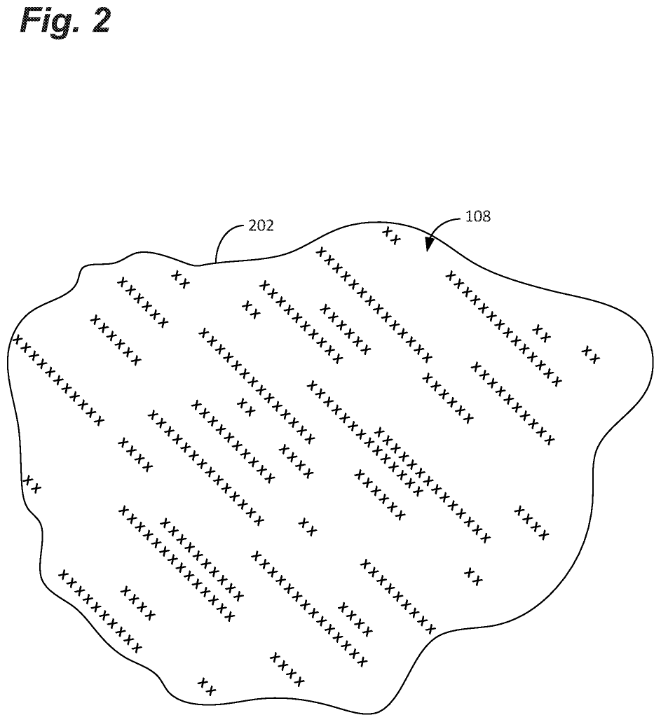

As shown in FIG. 2, the system 100 can use a plurality of probes 108 within a particular sample area 202. The sample area 202 can comprise the coverage area for a particular cell tower, group of cell towers, city, or some other relevant area. As discussed above, the probes 108 can be a plurality of UEs 102-106 running either a dedicated application 110 or an existing application reporting back to the QoS server 114.

The probes 108 preferably comprise a statistically significant number of UE 102-106, which can vary widely depending on the size of the sample area 202, the total number of users in the sample area 202 or on the network 116—i.e., larger networks with more users may tend to use larger sample sizes and vice-versa. In some examples, the probes 108 can also be selected to be geographically disparate. This can enable the system 100 to identify localized coverage issues, for example, or geographically based interference (e.g., buildings or mountains).

As shown in FIG. 3, examples of the present disclosure can also include a method 300 for detecting network congestion and other network conditions using QoS availability. As with the system 100 discussed above, the method 300 can use data collected from the probes 108 to directly measure network performance metrics such as, for example, upload and download speeds, latency, delay, and jitter. For ease of explanation, the method 300 is discussed below with reference to maximum download speed, but other metrics can be measured in a similar manner.

With regard to download speeds in newer, faster networks, the network provider may choose a target QoS availability that is likely to keep a majority of its customers happy without “maxing-out” the network 116. Thus, while a network may be capable of providing download speeds of up to 10 MB/s, for example, research may indicate that users are generally happy with at least 5 MB/s. In this case, the provider can set the QoS availability at 5 MB/s, for example, for at least 90 or 95% of the users. Of course, this number can vary from place to place (city vs. country, first world vs. third world, etc.) and application to application.

Older (e.g., 2G and 3G) networks, on the other hand, are generally slower than 4G LTE networks. As a result, for older networks, the QoS availability may be chosen simply as a percentage of the maximum download speed the network is capable of providing. If the network is only capable of providing 2 MB/s maximum download speed, for example, the target QoS availability may be set at 1.5 MB/s for 80 or 85% of the users. As with almost any business decision, ultimately, the target QoS availability can be chosen by the provider to maintain the balance between customers' satisfaction and managing network resources.

At 302, the QoS server 114 can receive probe data from the probes 108. In this case, the probe data may include, for example, the time of day, some identifying information for each of the probes 108 (e.g., model number, serial number, international mobile entity identification (IMEI), etc.), download size, download time (or average download speed), location, cell tower ID, etc. Of course, when measuring other metrics, the method 300 may use different or additional probe data.

As mentioned above, the data can be collected by a dedicated application 110 and/or one or more existing applications 112. The sample size can be any number and distribution relevant to the network service provider. In some examples, the applications 110, 112 can include location data, for example, to enable the method 300 to analyze a single cell, a sector of multiple cells, an entire city, etc. In this case, the probe data can also represent the true maximum download speed for each of the probes 108. Thus, applications 110 that run at less than maximum network capacity (e.g., streaming music or video) may not be useful for this particular metric (maximum download speed). To test download speeds, an FTP transfer application or a large file download such as, for example, an operating system (OS) update or a full-length movie may be more appropriate.

The number of samples can be large enough to be statistically significant and can cover a relevant time period, or service measurement period (SMP). In some examples, to identify congestion at peak times, the SMP can be from 8 AM-10 AM and 4 PM-6 PM, for example, when peak morning and evening data use, respectively, tend to occur. In other examples, to identify persistent, or chronic, congestion, the SMP can be days, weeks, or even months.

Regardless, at 304, once collected, the combined data can be sorted, compiled, and analyzed. In some examples, the combined data may be sorted by location, for example, to identify potential issues with localized equipment (e.g., overloaded cell cites). In other examples, the combined data can be sorted by the type of UEs 102-106. Older UE may have lower maximum download rates than what the network 116 can provide, for example; and thus, may tend to skew the combined data. Thus, older UEs 102-106 may be discarded when measuring download speeds, for example, but may be perfectly acceptable to measure other metrics (e.g., latency).

The combined data can also be sorted by time. Even when the SMP is chosen to target peak times, as discussed above, the SMP may be further sorted to identify trends within the SMP and provide additional data resolution. Thus, while 8 AM-10 AM may be a time of high traffic, there may be a spike in network traffic between 8:30 AM-9 AM, for example, when the most people are commuting to work. When the SMP is longer—e.g., over weeks or months—sorting by time can enable the provider to identify chronic congestion issues. Based on this information, the provider may decide to take action, or not. Congestion caused by OS update downloads at 2 AM, for example, may not effect customer satisfaction; and thus, a provider may decide not to address that issue. This can enable the network provider to identify peak traffic times and to measure network performance during peak usage, among other things.

Finally, the combined data can be analyzed to provide the service provider with usable network performance data. This may include statistical analysis such as, for example, calculating and graphing one or more cumulative distribution functions (CDFs). QoS Availability is a novel approach to provide a meaningful process of measuring, stating, and setting goals and targets associated with both network congestion and performance.

At 306, based on this analysis, the method 300 can extract the actual QoS availability for the sample area 202 over the SMP. In some examples, this can be described as the “area under the curve” of the CDF. In other examples, the QoS server 114 can merely calculate the actual QoS availability as the number of samples above the threshold (e.g., above 5 MB/s in the LTE example above) divided by the total number of samples. This results in a ratio, or percentage, of samples that are above the target QoS availability. QoS availability describes congestion in a concise, rigorous, and easily understood way.

At 308, the method 300 can determine if the actual QoS availability is equal to, or greater than, the target QoS availability. If the target QoS availability is 5 MB/s to 90% of the customers (5 Mbps @ 90% probability) and the actual QoS availability is 5 MB/s to 89% of the customers (5 Mbps @ 89% probability), the target QoS availability is not met. If, on the other hand, the target QoS availability is 5 MB/s to 90% (5 Mbps @ 90% probability) of the customers and the actual QoS availability is 5 MB/s to 90% or higher of the customers (5 Mbps @ >90% probability), the target QoS availability is met.

If the actual QoS availability is at, or above, the target QoS availability, then the method 300 can end or can return to block 302 to analyze new or different data. The method 300 may recheck data from the same sample area 202 periodically based, for example, on the SMP. If the SMP is one week for a particular sample area 202, for example, then the method can “run” the data from the sample area 202 once a week. The method 300 may also simply repeat to cycle through all of the sample areas 202 in the entire network 116. As discussed below, this data can be aggregated to analyze the network 116 over a larger area than the SMP, for example, or over the entire network.

If the actual QoS availability is below the target QoS availability, on the other hand, then at 310, the method 300 can register a “hit.” Detection of a single hit does not necessarily constitute congestion, as congestion is generally defined as a chronic issue. A hit means that the cell was congested during the SMP of a particular day or at a particular time. This may be a localized or temporary problem, however, that does not necessarily need to be addressed. An event that happens once a year (e.g., a St. Patrick's Day parade) may not warrant action by the provider. In other words, the cost to improve performance one day a year may outweigh the perceived benefits to users.

To identify persistent congestion, therefore, at 312, hits for a particular area can be aggregated and analyzed. Thus, the method 300 can include aggregating the QoS availability over a period of time (e.g., several SMPs) to determine if congestion is chronic. The QoS availability can be aggregated over the course of a 24-hour period, a week, several weeks, or even months.

Congestion can be defined by the service provider and may vary depending on location, type of service (e.g., 3G vs. 4G LTE), market forces, etc. In some examples, a cell may be determined to be congested, for example, if the cell was congested on a certain number of days (e.g., 2 or 3 out of 7). In other examples, the method can calculate the weighted average for QoS availability over a number of samples (e.g., the 5 worst days out of the last 14 days). Note that the weighting can be based on usage—which can be defined as “radio resource control connected users,” or RRC_CU—for a particular day to the total of the RRC_CU load over those 5 days. So, for Day 1 of the 5 worst days, for example, the weighting factor for Day 1 is:

$${Weight}_{{Day}_{{SMP}_{i}}} = \frac{{RRC\_CU}_{{Day}_{{SMP}_{i}}}}{{\sum }_{∀ Days \_ SMPs} ( {RRC\_CU}_{{Day}_{{SMP}_{i}}} )}$$

Then the weighted average of QoS availability over those five days is:

$${QoS}_{{Availability}_{5 Worst Days}} = \frac{{\sum }_{∀ Days \_ SMPs} ( {QoS}_{{Availability}_{{Day}_{{SMP}_{i}}}} \times {RRC}_{{CU}_{{Day}_{{SMP}_{i}}}} )}{{\sum }_{∀ Days \_ SMPs} ( {RRC\_CU}_{{Day}_{{SMP}_{i}}} )}$$

If the weighted average QoS availability is below the target QoS availability, then the cell can be declared congested.

At 314, each “issue” can then be evaluated to determine if a solution is available, desirable, and/or practical. In practice, failure to meet the desired QoS availability is often due to actual congestion; however, some cases can be related to coverage and/or performance issues. In some cases, the issue may simply be a lack of capacity to meet demand in a particular cell—or, the previously discussed congestion-based QoS availability. If the congestion is persistent, then additional equipment (e.g., transceivers and antennas) can be added to existing cell sites, for example, or new cell sites can be constructed. Similarly, performance issues caused by lack of coverage can be remedied by installing additional cell sites, for example, or partnering with providers with existing cell sites.

Performance issues may also be caused by network “back-end” components. An outdated 3GPP AAA server 128, for example, may be slow to respond to authorization requests resulting in back-ups. Similarly, a failing HLR/HSS 118 may be slow to provide lookup information (e.g., user-related and subscription-related information) or may intermittently fail to provide lookup information. In either case, new or additional servers can be installed to remedy the issue. The first step in the process is obviously to identify the performance issue using the systems 100 and methods 300 described herein.

Indeed, QoS availability for the entire network, or total QoS availability, can be determined by “rolling-up” the QoS availability of all the cells/sectors on the network 116. Thus, the sum of the weighted RRC_CU QoS availability of each network sector or cell (or whatever resolution was used during initial aggregation) can be averaged to determine overall QoS availability. As mentioned above, QoS availability can be calculated for any desired resolution including, for example, at the cell level, the sector level (a cell is typically part of a sector, which can include a plurality of cells), the city level, the regional level, etc.

Using sector level resolution, for example, the total QoS availability can be expressed as:

$${QoS}_{{Availability}_{Network}} = \frac{{\sum }_{{∀ Sectors}_{∀ Days \_ SMPs}} ( {QoS\_Availability}_{i} * {RRC\_CU}_{i} )}{{\sum }_{{∀ Sectors}_{∀ Days \_ SMPs}} ( {RRC\_CU}_{i} )}$$

Thus, examining the QoS availability on a cell-by-cell or sector-by-sector basis can enable the provider to identify localized issues such as those discussed above. Examining total QoS availability, on the other hand, can enable the provider to assess overall network health and can be used to accurately represent what level of service is being provided to users. This can enable the provider to identify trends on the macro level to add capacity, for example, before congestion becomes an issue.

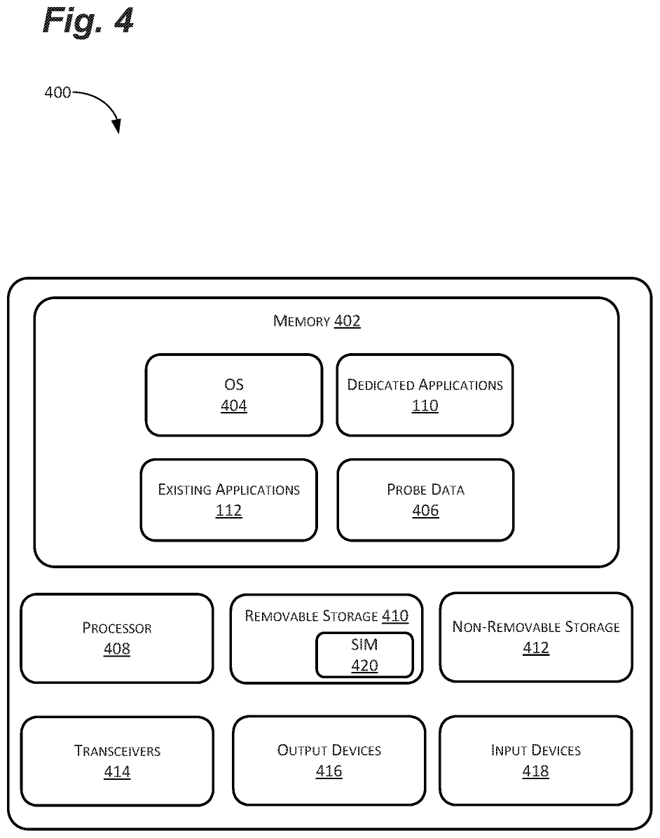

FIG. 4 depicts a component level view of a UE 400 (e.g., any of the UEs 102-106) for use with the system 100 and method 300 described herein. The UE 400 could be any UE suitable for use as a probe 108 in the system 100. For clarity, the UE 400 is described herein generally as a cell phone or smart phone. One of skill in the art will recognize, however, that the system 100 and method 300 described herein can also be used with a variety of other electronic devices, such as, for example, tablet computers, laptops, desktops, and other network (e.g., cellular or IP network) connected devices.

The UE 400 can comprise several components to execute the above-mentioned functions. As discussed below, the UE 400 can each comprise memory 402 including many common features such as, for example, contacts, calendars, call logs, voicemail, etc. The memory 402 can also include the operating system (OS) 404. In this case, the UE can also comprise one or more dedicated applications 110, one or more existing applications 112, and can store probe data 406 The UE 400 can also comprise one or more processors 408. The UE 400 can also include one or more of removable storage 410, non-removable storage 412, transceiver(s) 414, output device(s) 416, and input device(s) 418. In some examples, such as for cellular communication devices, the UE 400 can also include a SIM 420 including an international mobile subscriber identity (IMSI), and other relevant information.

In various implementations, the memory 402 can be volatile (such as random access memory (RAM)), non-volatile (such as read only memory (ROM), flash memory, etc.), or some combination of the two. The memory 402 can include all, or part, of the functions 110, 112, 406 and the OS 404 for the UE 400, among other things. In some examples, rather than being stored in the memory 402, some, or all, of the functions and messages can be stored on a remote server or cloud of servers accessible by the probes 108.

The memory 402 can also include the OS 404. Of course, the OS 404 varies depending on the manufacturer of the probes 108 and currently comprises, for example, iOS 11.2.6 for Apple products and Oreo for Android products. The OS 404 contains the modules and software that support a computer's basic functions, such as scheduling tasks, executing applications, and controlling peripherals. In some examples, the OS 404 can receive signals from the dedicated application 110 and/or the existing application 112, for example, to cause the UE 400 to store the probe data 406, download files, and transmit probe data 406 to the QoS server 114. The OS 404 can also enable the UE 400 to send and retrieve data via an internet connection and perform other functions.

The UE 400 can also include one or more dedicated applications 110 and one or more existing applications 112 configured for use with the system 100. In some examples, the dedicated applications 110 can be configured to, for example, upload and/or download a sample file, ping a server, or perform other functions to obtain the probe data 406. In other examples, the system 100 can “piggyback” on the existing applications 112 to obtain the probe data 406. Of course, the applications 110, 112 can be chosen to provide valid data. So, for example, an FTP downloading application could be modified to provide upload and/or download rates to the probe data 406 each time it is used, but may not be appropriate to measure jitter. Similarly, a streaming video application could be used to provide probe data 406 related to jitter, latency, or delay, but may not be suitable to measure download speeds because streaming applications do not typically “max out” download speed.

The probe data 406 can include the data collected from the dedicated applications 110 and the existing applications 112. The probe data 406 can be stored in the memory 402, for example, and then can be periodically uploaded to the QoS server 114 (e.g., hourly, daily, weekly, etc.). Depending on the applications 110, 112 installed, the probe data 406 can include data related to upload and download speeds, latency, delay, jitter, or other performance data. In some examples, the probe data 406 can be collected from multiple applications 110, 112, with each application 110, 112 chosen based on its ability to provide one or more types of probe data, as discussed above.

The UE 400 can also comprise one or more processors 408. In some implementations, the processor(s) 408 can be a central processing unit (CPU), a graphics processing unit (GPU), or both CPU and GPU, or any other sort of processing unit. The UE 400 may also include additional data storage devices (removable and/or non-removable) such as, for example, magnetic disks, optical disks, or tape. Such additional storage is illustrated in FIG. 4 by removable storage 410 and non-removable storage 412. The removable storage 410 and non-removable storage 412 can store some, or all, of the functions 110, 112, 406 and/or the OS 404.

Non-transitory computer-readable media may include volatile and nonvolatile, removable and non-removable tangible, physical media implemented in technology for storage of information, such as computer readable instructions, data structures, program modules, or other data. The memory 402, removable storage 410, and non-removable storage 412 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store the desired information and which can be accessed by the UE 400. Any such non-transitory computer-readable media may be part of the UE 400 or may be a separate database, databank, remote server, or cloud-based server.

In some implementations, the transceiver(s) 414 include any sort of transceivers known in the art. In some examples, the transceiver(s) 414 can include wireless modem(s) to facilitate wireless connectivity with the other UE, the Internet, and/or an intranet via the cellular network 116. Further, the transceiver(s) 414 may include a radio transceiver that performs the function of transmitting and receiving radio frequency communications via an antenna (e.g., Wi-Fi or Bluetooth®). In other examples, the transceiver(s) 414 may include wired communication components, such as a wired modem or Ethernet port, for communicating with the other UE or the provider's internet-based network. The transceiver(s) 414 can enable the UE 400 to upload and download data with the applications 110, 112, for example, and to transmit the probe data 406 to the QoS server 114 via a cellular or internet data connection.

In some implementations, the output device(s) 416 include any sort of output devices known in the art, such as a display (e.g., a liquid crystal or thin-film transistor (TFT) display), a touchscreen display, speakers, a vibrating mechanism, or a tactile feedback mechanism. In some examples, the output devices can play various sounds based on, for example, when a file has completed downloading, when probe data 406 is transmitted to the QoS server 114, or to signify other events. Output device(s) 416 also include ports for one or more peripheral devices, such as headphones, peripheral speakers, or a peripheral display.

In various implementations, input device(s) 418 include any sort of input devices known in the art. For example, the input device(s) 418 may include a camera, a microphone, a keyboard/keypad, or a touch-sensitive display. A keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. In some examples, the UE 400 can include a touchscreen, for example, to enable the user to make selections in the applications 110, 112, start downloads, etc.

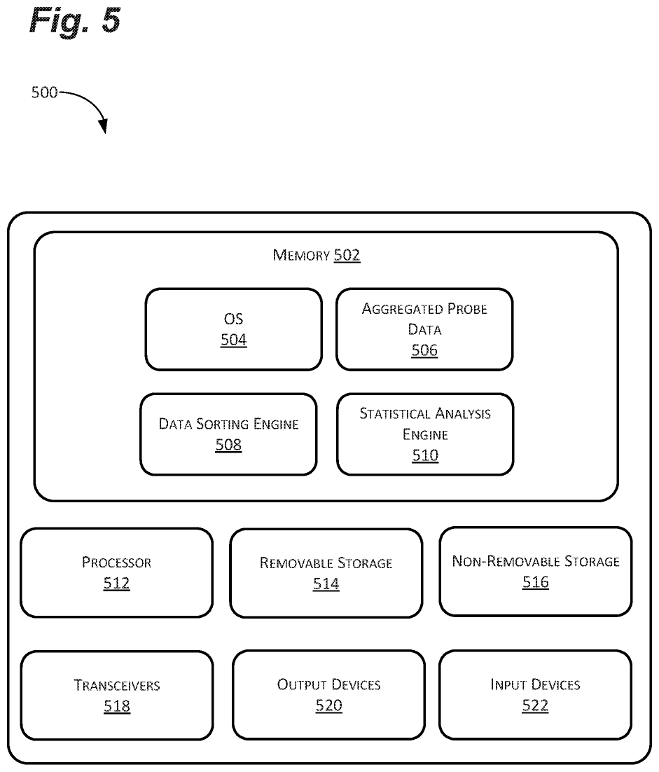

As shown in FIG. 5, the system 100 and method 300 can also be used in conjunction with the QoS server 114. To simplify the discussion, the QoS server 114 is discussed below as a standalone server. One of skill in the art will recognize, however, that the system 100 and method 300 disclosed herein can also be implemented partially, or fully, on a network entity such as, for example, the PCRF 140 or 3GPP AAA server 128. Thus, the discussion below in terms of the QoS server 114 is not intended to limit the disclosure to the use of a standalone server.

The server 500 can comprise a number of components to execute the above-mentioned functions and applications. As discussed below, the server 500 can comprise memory 502 including, for example, an OS 504, combined probe data 506, a data sorting engine 508, and a statistical analysis engine 510. In various implementations, the memory 502 can be volatile (such as RAM), non-volatile (such as ROM, flash memory, etc.), or some combination of the two. The memory 502 can include all, or part, of the functions 506, 508, 510 for the server 500, among other things.

The memory 502 can also include the OS 504. Of course, the OS 504 varies depending on the manufacturer of the server 500 and the type of component. Many servers, for example, run Linux or Windows Server. Dedicated cellular routing servers may run specific telecommunications OSs 504. The OS 504 contains the modules and software that supports a computer's basic functions, such as scheduling tasks, executing applications, and controlling peripherals. The OS 504 can enable the server

In this case, the server 500 can also include the combined probe data 506. The combined probe data 506 can comprise the probe data 406 from all probes 108 and may include both sorted and unsorted data. As discussed below, the combined probe data 506 can be sorted, compiled, and analyzed to provide metrics and identify trends related to network performance. The combined probe data 506 can also be analyzed to locate hits—instances where QoS availability targets were not met—which can be aggregated for additional analysis, as discussed above.

The server 500 can also comprise the data sorting engine 508 and the statistical analysis engine 510. As the name implies, the data sorting engine 508 can sort the combined probe data 506 to enable further analysis. The data sorting engine 508 can use data contained in the probe data 406 to sort the combined probe data 506 by, for example, geographical location, market size, traffic volume, or any other metric. The data sorting engine 508 may sort probe data 406 into categories including cell site, sector, city, etc. The data sorting engine 508 can also sort the combined probe data 506 according to what performance metric the data is directed. Probe data 406 can be sorted by data associated with download or upload speed, latency, delay, jitter, etc. Thus, data from an existing application 112 used for video streaming to measure latency, for example, is not included for analysis of download speeds with data from an FTP download application.

The statistical analysis engine 510 can take the combined probe data 506, perform statistical analysis, graph the results, and provide summary data. The summary data can summarize performance metrics for a particular cell or sector, for example, or for an entire city or network 116, as discussed above. The statistical analysis engine 510 can calculate CDFs, probability density function (PDF), histogram, average, maximum, minimum, variance, etc.

The server 500 can also comprise one or more processors 512. In some implementations, the processor(s) 512 can be a central processing unit (CPU), a graphics processing unit (GPU), or both CPU and GPU, or any other sort of processing unit. The server 500 can also include one or more of removable storage 514, non-removable storage 516, transceiver(s) 518, output device(s) 520, and input device(s) 522.

The server 500 may also include additional data storage devices (removable and/or non-removable) such as, for example, magnetic disks, optical disks, or tape. Such additional storage is illustrated in FIG. 5 by removable storage 514 and non-removable storage 516. The removable storage 514 and non-removable storage 516 can store some, or all, of the OS 504 and functions 506, 508, 510.

Non-transitory computer-readable media may include volatile and nonvolatile, removable and non-removable tangible, physical media implemented in technology for storage of information, such as computer-readable instructions, data structures, program modules, or other data. The memory 502, removable storage 514, and non-removable storage 516 are all examples of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired information and which can be accessed by the server 500. Any such non-transitory computer-readable media may be part of the server 500 or may be a separate database, databank, remote server, or cloud-based server.

In some implementations, the transceiver(s) 518 include any sort of transceivers known in the art. In some examples, the transceiver(s) 518 can include wireless modem(s) to facilitate wireless connectivity with the UE, the Internet, the cellular network 116, and/or an intranet via a cellular connection. Further, the transceiver(s) 518 may include a radio transceiver that performs the function of transmitting and receiving radio frequency communications via an antenna (e.g., Wi-Fi or Bluetooth®) to connect to the IP network 118. In other examples, the transceiver(s) 518 may include wired communication components, such as a wired modem or Ethernet port. The transceiver(s) 518 can enable the server 500 to communicate with the probes 108, receive probe data 406, and communicate with other network entities.

In some implementations, the output device(s) 520 include any sort of output devices known in the art, such as a display (e.g., a liquid crystal or thin-film transistor (TFT) display), a touchscreen display, speakers, a vibrating mechanism, or a tactile feedback mechanism. In some examples, the output devices can play various sounds based on, for example, whether the server 500 is connected to a network, when probe data 406 is received, when statistical analysis or sorting is complete, etc. Output device(s) 520 also include ports for one or more peripheral devices, such as headphones, peripheral speakers, or a peripheral display.

In various implementations, input device(s) 522 include any sort of input devices known in the art. For example, the input device(s) 522 may include a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

While several possible examples are disclosed above, examples of the present disclosure are not so limited. For instance, while the systems and methods above are discussed with reference to use with cellular communications, the systems and methods can be used with other types of wired and wireless communications. In addition, while various functions are discussed as being performed on the server 500 and/or by the probes 108, other components, such as network entities, could perform the same or similar functions without departing from the spirit of the invention. In addition, while the disclosure is primarily directed to using UEs 102-106 running applications 110, 112 to gather performance data, it can also be used on other devices (e.g., machine-to-machine (M2M) or IoT devices) on the same, or similar, networks or future networks. Indeed, the system 100 and method 300 can be applied to virtually any network where data is transferred and QoS is a concern.

Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

What is claimed is:

1. A quality of service (QoS) server associated with a network, the QoS server comprising:
one or more inputs;
one or more transceivers to send and receive one or more wired or wireless transmissions;
memory storing at least combined probe data, a data sorting engine, and a data analysis engine; and
one or more processors in communication with at least the one or more transceivers and the memory, the memory including computer executable instructions to cause the one or more processors to:
receive, from the one or more inputs, a target QoS availability for the network, the target QoS availability including a performance metric and a probability;
receive, from the one or more transceivers, probe data from a plurality of users' equipment (UEs);
store, in the memory, combined probed data comprising the probe data from the plurality of UEs; and
analyze, with the data analysis engine, the combined probe data to identify hits, the hits associated with network performance that is below the target QoS availability.

2. The QoS server of claim 1, wherein each of the plurality of UEs are running at least one application configured to collect the probe data; and
wherein the probe data is related to network performance.

3. The QoS server of claim 1, the performance metric comprising a minimum download speed; and
the probability comprising a percentage of a total number of users on the network or a portion of the network.

4. The QoS server of claim 1, the computer executable instructions further causing the one or more processors to:
aggregate, with the data analysis engine, the hits for a portion of the network;
determine, with the data analysis engine, that the hits for a portion of the network exceed a predetermined number of hits; and
determine, with the data analysis engine, the portion of the network is congested based at least in part on the predetermined number of hits.

5. The QoS server of claim 4, the computer executable instructions further causing the one or more processors to:
analyze, with the data analysis engine, the portion of the network to identify one or more issues with the portion of the network causing the congestion.

6. The QoS server of claim 5, wherein a first issue of the one or more issues comprises a malfunctioning network entity in the portion of the network.

7. A method comprising:
receiving, at a transceiver of a quality of service (QoS) server, probe data from a plurality of applications running on a plurality of users' equipment (UEs) associated with a network;
sorting, with a processor of the QoS server; the probe data into one or more categories based at least in part on the application from which the probe data was received; and
analyzing, with the processor of the QoS server, a first category of probe data from a first application running on at least a portion of the plurality of UEs to identify one or more first hits, the first hits associated with network performance that is below a first target QoS availability;
wherein one or more metrics associated with the first target QoS availability are based at least in part on the probe data.

8. The method of claim 7, wherein the first application is an application that uses a maximum download speed of the network; and
wherein the first target QoS availability includes a percentage of UEs that receive at least a minimum download speed on the network.

9. The method of claim 8, wherein the first target QoS availability is 90% of the UEs receiving at least 5 Mbps download speeds.

10. The method of claim 7, further comprising:
aggregating, with the processor of the QoS server, a number of first hits for a portion of the network;
determining, with the processor of the QoS server, that the number of first hits is above a predetermined number of first hits; and
determining, with the processor of the QoS server, that the portion of the network is congested based at least in part on the number of first hits being above the predetermined number of first hits.

11. The method of claim 7, wherein the first application is a video streaming application; and
wherein the first target QoS availability includes a percentage of UEs that receive a session startup latency that is less than a predetermined time period on the network.

12. The method of claim 11, wherein the first target QoS availability comprises 95% of the UEs receiving a session startup latency of less than 1 ms.

13. The method of claim 7, further comprising:
analyzing, with the processor of the QoS server, a second category of probe data from a second application running on at least a portion of the plurality of UEs to identify one or more second hits, the second hits associated with network performance that is below a second target QoS availability;
wherein the second target QoS availability includes at least one metric that is different than at least one metric of the first target QoS availability.

14. A method comprising:
running, with a processor of a user equipment (UE), a first application configured to gather probe data associated with the performance of a communications network;
storing, in a memory of the UE, the probe data for a predetermined amount of time; and
sending, with a transceiver of the UE, the probe data to a quality of service (QoS) server associated with the network for analysis by the QoS server.

15. The method of claim 14, wherein the first application is a dedicated application configured to cause the UE to:
download, with the transceiver, a test file from a test site associated with the network; and
store, in the memory, data related to the download including at least a download speed.

16. The method of claim 14, wherein the first application is a dedicated application configured to cause the UE to:
ping, with the transceiver, a test site associated with the network a predetermined number of times; and
store, in the memory, data related to the pings, the data associated with at least one of a delay or a latency of the network.

17. The method of claim 14, wherein the first application is an existing application modified to gather data related to network performance as it operates.

18. The method of claim 17, wherein the existing application is a streaming application modified to gather data regarding at least one of latency, delay, or jitter.

19. The method of claim 17, wherein the existing application is a file transfer protocol (FTP) application modified to gather data regarding download speeds associated with the network.

20. The method of claim 17, wherein the existing application is a software update application configured to download an update from an update server and to gather data regarding download speeds associated with the network.
